(19) United States
(12) Patent Application Publication
(10) Pub. No.: US 2022/0210378 A1
(43) Pub. Date: Jun. 30, 2022

(54) IMAGE PROCESSING DEVICE, LENS MODULE, AND IMAGE PROCESSING METHOD

(71) Applicant: HON HAI PRECISION INDUSTRY CO., LTD., New Taipei (TW)

(72) Inventors: TE-EN TSENG, New Taipei (TW); TSAI-YI CHIEN, New Taipei (TW)

(21) Appl. No.: 17/536,275

(22) Filed: Nov. 29, 2021

(30) Foreign Application Priority Data
Dec. 24, 2020 (CN) 202011553202.0

(51) Int. Cl. H04N 9/04; G02B 3/00

(52) U.S. Cl. CPC H04N 9/04557; H04N 9/04515; G02B 3/0018

(57) ABSTRACT

An image processing device includes an image sensor and an image signal processor. The image sensor includes a pixel array and a filter array. The filter array is arranged corresponding to the pixel array and includes a plurality of filter units. The plurality of filter units divides the pixel array into a plurality of pixel units. Each pixel unit includes a plurality of pixels. Each filter unit corresponds to one pixel unit and allows only one kind of colored light to be incident on the corresponding pixel unit to generate a first Bayer image. The image signal processor is electrically coupled to the image sensor to receive the first Bayer image output by the image sensor and processes the first Bayer image to output a first image or a second image.

### FIELD

The subject matter herein generally relates to an image processing device, and more particularly to an image processing device for a lens module.

### BACKGROUND

Referring to FIG. 1 and FIG. 2, a photosensitive area of a large pixel is larger than a photosensitive area of a small pixel. When light is incident on a large pixel, the light enters fewer adjacent pixels. Thus, the use of large pixels can effectively reduce the problem of color crosstalk between pixels, and can further effectively reduce the impact of large-angle scattered light and dispersive light on adjacent pixels. Therefore, existing periscope lens module adopts larger-sized pixels and smaller apertures to reduce color crosstalk between pixels and reduce the influence of large-angle scattered light and dispersive light. However, when larger-sized pixels are used, the number of pixels is correspondingly reduced, which will reduce an image resolution. Furthermore, the smaller aperture is not conducive to capturing in dark scenes. For example, an aperture value of the periscope lens module mounted on mobile phones is generally in the range of F5.0-F3.0, and a unit area of each pixel is generally in the range of 1.0-1.12 microns. Therefore, this configuration results in poor imaging quality.

### BRIEF DESCRIPTION OF THE DRAWINGS

Implementations of the present disclosure will now be described, by way of embodiments, with reference to the attached figures.

FIG. 1 is a schematic diagram of light entering a small pixel.

FIG. 2 is a schematic diagram of light entering a large pixel.

FIG. 3 is a schematic block diagram of a lens module according to an embodiment of the present disclosure.

FIG. 4 is an exploded schematic diagram of an image sensor in the lens module shown in FIG. 3.

FIG. 5 is a schematic diagram of the image sensor shown in FIG. 4.

FIG. 6 is a cross-sectional diagram taken along view line VI-VI in FIG. 5.

FIG. 7 is a schematic diagram of a first Bayer image.

FIG. 8 is a schematic diagram of a filter array and a micro lens array shown in FIG. 4.

FIG. 9 is a schematic diagram of a second Bayer image.

FIG. 10 is a schematic diagram of a third Bayer image.

FIG. 11 is a flowchart of an image processing method according to an embodiment of the present disclosure.

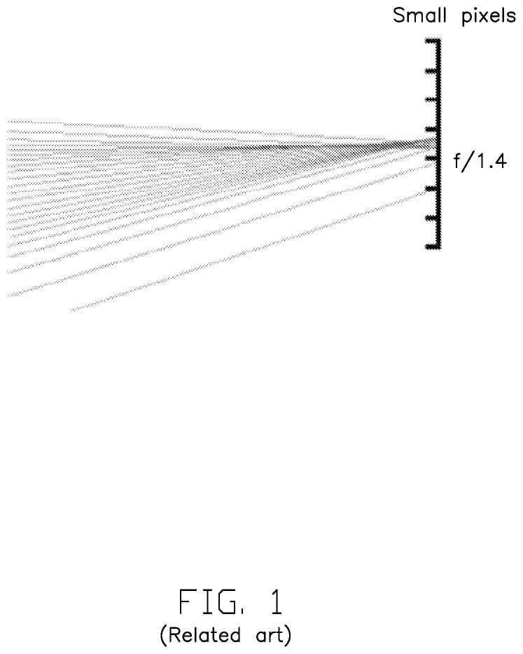

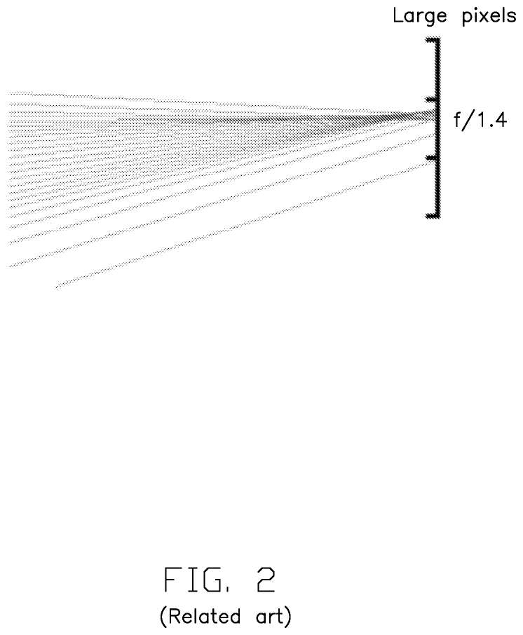

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably connected. The term “comprising” means “including, but not necessarily limited to”; it specifically indicates open-ended inclusion or membership in a so-described combination, group, series, and the like.

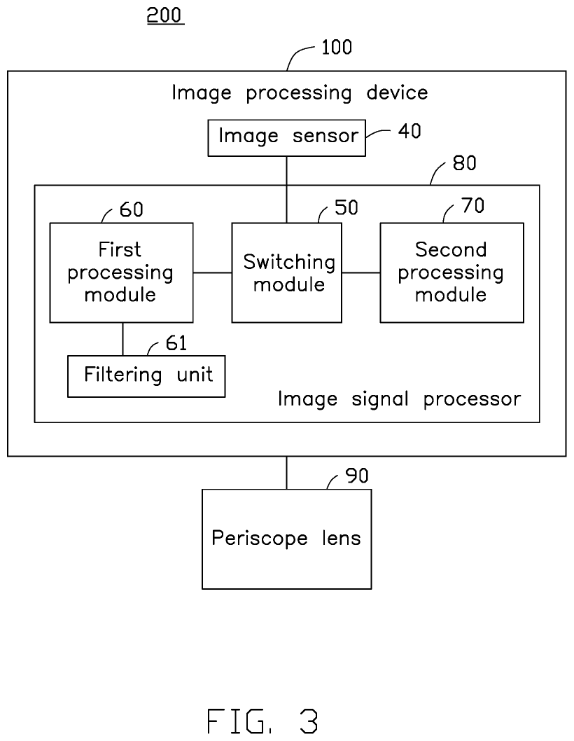

FIG. 3 shows an embodiment of an image processing device 100 that can be applied to a lens module 200 to improve an imaging quality of the lens module 200. The image processing device 100 includes an image sensor 40 (CMOS image sensor, CIS) and an image signal processor 80 (ISP). The image sensor 40 is used to convert a collected light signal into an electrical signal and output a first Bayer image. The image signal processor 80 is electrically coupled to the image sensor 40 for receiving the first Bayer image and correspondingly outputting a first image or a second image after processing the first Bayer image.

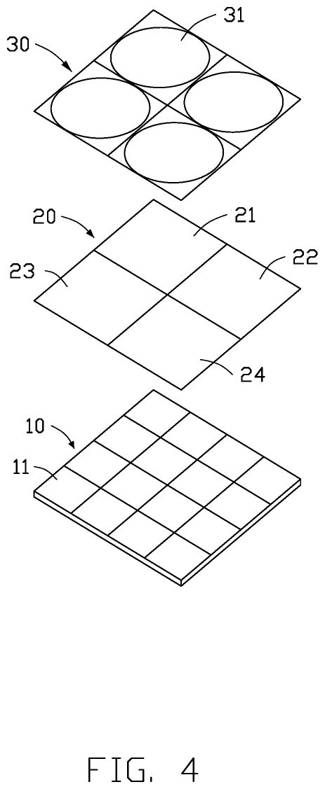

Referring to FIG. 4, the image sensor 40 includes a pixel array 10, a filter array 20 and a micro lens array 30.

The pixel array 10 includes a plurality of pixels 11. The pixels 11 form an array in the form of N*M. Among them, N and M are both positive integers, and the values of N and M can be equal or unequal. For example, in one embodiment, N and M are both equal to 4, so the pixels 11 form a 4*4 array. A unit area of each pixel 11 may be less than 1 micron. In one embodiment, the unit area of each pixel 11 is 0.8 microns.

The filter array 20 is arranged corresponding to the pixel array 10. In one embodiment, a shape and size of the filter array 20 correspond to a shape and size of the pixel array 10. The filter array 20 includes a plurality of filter units. Each filter unit includes at least one filter for filtering incident light, so that a colored light enters the corresponding pixel 11 through the filter array 20.

In one embodiment, the filter array 20 includes four filter units, namely a first filter unit 21, a second filter unit 22, a third filter unit 23, and a fourth filter unit 24. The first filter unit 21, the second filter unit 22, the third filter unit 23, and the fourth filter unit 24 are arranged adjacent to each other and form a 2*2 filter array.

In one embodiment, each of the filter units allows only one type of colored light to pass through. For example, the first filter unit 21 and the fourth filter unit 24 located in opposite corners of the filter array 20 only allow light of a first color, such as green, to pass through, the second filter unit 22 located at another corner of the filter array 20 only allows light of a second color, such as red, to pass through, and the third filter unit 23 located at another corner of the filter array 20 only allows light of a third color, such as blue, to pass through. In this way, the first filter unit 21, the second filter unit 22, the third filter unit 23, and the fourth filter unit 24 can form a four-Bayer color filter array in the form of GRBG. In other embodiments, the four-Bayer color filter array formed by the filter array 20 is not limited to the GRBG format described above and may be in other formats, such as RGGB or BGGR. In addition, the arrangement of the filter units in the filter array 20 is not limited to the arrangement of the 2*2 filter units as described above. In other embodiments, the filter units of the filter array 20 may be arranged in an array of 3*3 filter units.

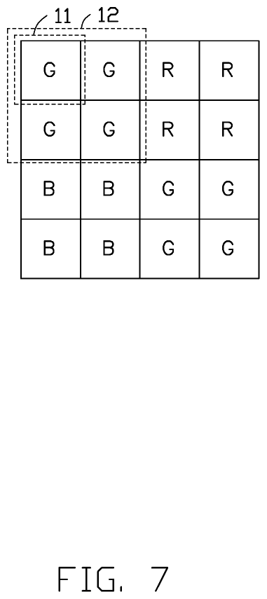

Referring to FIG. 7, in one embodiment, the filter units divide the pixel array 10 into a plurality of pixel units 12. Each pixel unit 12 includes a plurality of the pixels 11. Each filter unit is respectively arranged corresponding to the corresponding pixel unit 12 in the pixel array 10 and allows one kind of colored light to be incident on the pixel unit 12. In one embodiment, the four filter units correspond to four pixel units 12, respectively. Thus, the number of the pixel units 12 corresponds to the number of the filter units.

In one embodiment, a shape and size of the filter array 20 correspond to a shape and size of the pixel array 10, and each filter unit corresponds to one pixel unit 12. Therefore, the pixel array 10 is divided into a corresponding number of pixel units 12 according to the number of the pixel units 12, that is, the pixel array 10 is divided into 4 pixel units 12. Each pixel unit 12 is composed of an array of M1*M2. M1 and M2 are both positive integers greater than 1, and the two may be the same or different. For example, in one embodiment, both M1 and M2 are equal to 2.

In one embodiment, since the first filter unit 21, the second filter unit 22, the third filter unit 23, and the fourth filter unit 24 respectively correspond to four adjacent pixel units on the pixel array 10, each pixel unit 12 includes 2*2 pixels 11, and each pixel 11 in each pixel unit 12 filters the same color light.

Specifically, in one embodiment, when the filter array 20 is arranged according to the GRBG four-Bayer color filter array, light of a specific wavelength (such as red light, green light, or blue light) can be transmitted, so that the pixel array 10 outputs a first Bayer image (see FIG. 7). The first Bayer image is arranged in a 4*4 array. A pixel value of each pixel 11 in the pixel unit 12 located in the upper left corner is a pixel value of a G color channel, the pixel value of each pixel 11 in the pixel unit 12 located in the upper right corner is the pixel value of an R color channel, the pixel value of each pixel 11 in the pixel unit 12 located in the lower left corner is a pixel value of a B color channel, and the pixel value of each pixel 11 in the pixel unit 12 located in the lower right corner is a pixel value of a G color channel. Thus, each pixel 11 in the first Bayer image has only one pixel value in the three color channels of RGB.

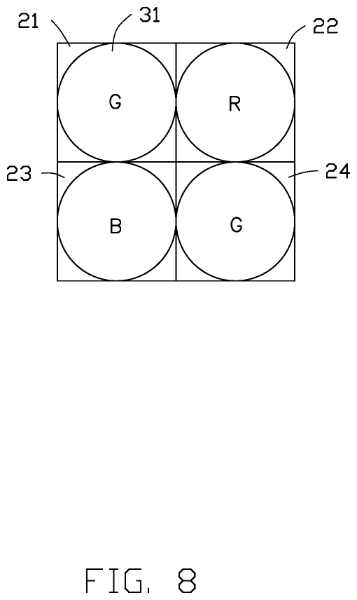

Referring to FIGS. 4-8, the micro lens array 30 is used to focus the incident light, so that the focused incident light is projected to the filter array 20. The micro lens array 30 is arranged on a side of the filter array 20 away from the pixel array 10. The micro lens array 30 includes a plurality of micro lenses 31. Each of the micro lenses 31 is arranged corresponding to one filter unit of the filter array 20. Thus, each micro lens 31 is arranged corresponding to one pixel unit 12. In this way, each of the pixel units 12 on the pixel array 10 can use the same color filter and share the same micro lens 31.

In the pixel array in the related art, each pixel corresponds to one micro lens, and a gap exists between each two adjacent micro lenses. When incident light enters the gap between the micro lenses, a portion of the incident light cannot be converted into electrical signals, which will reduce a utilization rate of the incident light. In the present disclosure, the micro lenses 31 are arranged corresponding to the filter units and the pixel units 12, so that a plurality of pixels 11 form one pixel unit and share one micro lens 31, which can effectively reduce the gaps between adjacent micro lenses 31 and increase utilization of the incident light.

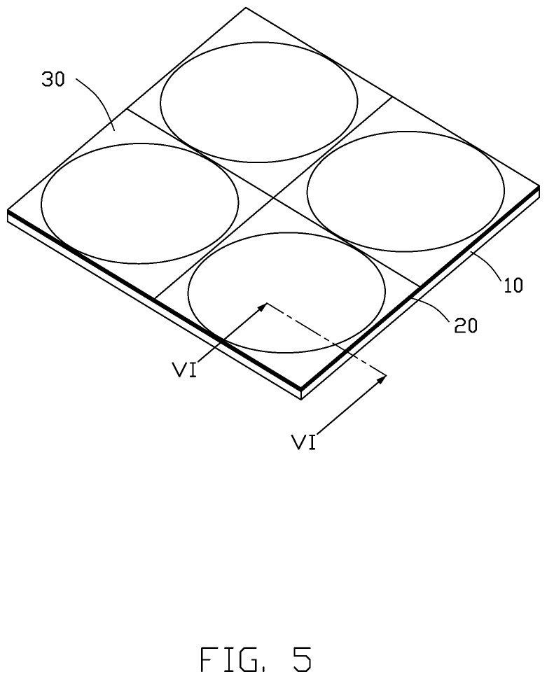

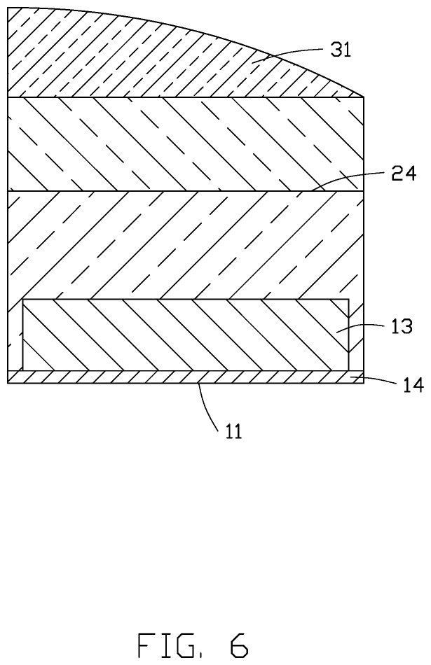

Referring to FIGS. 5-6 together, each pixel 11 on the pixel array 10 is further provided with a photodiode (PD) 13 and a readout circuit 14. The photodiode 13 is used to perform photoelectric conversion on the light absorbed by each pixel 11 to obtain a corresponding electrical signal. The readout circuit 14 is used to read out the electrical signal to obtain the light intensity value of the predetermined wavelength corresponding to each pixel 11. In this way, the first Bayer image can be obtained according to the light intensity value of each pixel 11.

It can be understood that when incident light enters, the incident light will pass through the micro lens array 30, the filter array 20, and the pixel array 10 in sequence. The incident light is first condensed by the micro lens array 30, and then each filter unit in the filter array 20 filters the condensed incident light and enters the pixel array 10, so that the pixel unit 12 corresponding to each filter unit is illuminated by one of the three colors of RGB light. Then, the photodiode 13 and the readout circuit 14 on each pixel 11 obtain the light intensity value of the colored light corresponding to each pixel 11 to generate the first Bayer image.

Referring to FIG. 3 again, the image signal processor 80 is electrically coupled to the image sensor 40 to obtain the first Bayer image generated by the image sensor 40. The image signal processor 80 processes the first Bayer image according to a current mode of the image signal processor 80 and outputs a first image or a second image.

In one embodiment, the image signal processor 80 includes a switching module 50, a first processing module 60, and a second processing module 70. The switching module 50 is electrically coupled to the image sensor 40. The first processing module 60 and the second processing module 70 are electrically coupled to the switching module 50. The switching module 50 is configured to receive the first Bayer image output by the image sensor 40, and select or trigger the first processing module 60 or the second processing module 70 according to the current mode of the image signal processor 80, so that the first processing module 60 or the second processing module 70 processes the first Bayer image, and then outputs the first image or the second image.

For example, when the switching module 50 receives the first Bayer image and determines that the image signal processor 80 is in the first mode, the first processing module 60 will be selected or triggered. The first processing module 60 receives the first Bayer image transmitted by the switching module 50 and performs Remosaic processing on the first Bayer image to obtain the second Bayer image (see FIG. 9). Then, the first processing module 60 performs Demosaic processing on the second Bayer image to obtain the first image.

Referring to FIG. 9, the Remosaic processing refers to processing the first Bayer image shown in FIG. 7 into the second Bayer image shown in FIG. 9, that is, processing the four-Bayer color filter array image into a standard Bayer color filter array image. Compared to the four-Bayer color filter array image shown in FIG. 7, the standard Bayer color filter array image shown in FIG. 9 is formed by the arrangement of eight green pixels, four blue pixels, and four red pixels, so that besides the green pixels located at an edge of the image, each green pixel is surrounded by two red pixels, two blue pixels, and four green pixels in the second Bayer image. In the second Bayer image, each pixel only has the pixel value of one of the three RGB channels.

The Demosaic processing refers to processing the second Bayer image into the first image. The first image is an RGB image where each pixel has three RGB color channels. The Remosaic processing and Demosaic processing can be implemented by different interpolation algorithms, such as linear interpolation, mean interpolation, etc., which will not be repeated here.

The image signal processor 80 further includes a filter unit 61. The filter unit 61 is electrically coupled to the first processing module 60. The filter unit 61 is configured to perform mean filtering on each pixel unit 12 in the first Bayer image before generating the second Bayer image. In this way, the influence of scattered light and dispersive light on the first Bayer image is reduced, thereby effectively reducing color crosstalk of pixels in the generated second Bayer image.

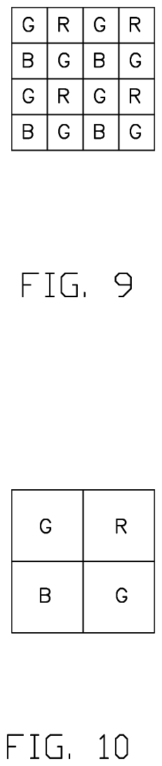

When the switching module 50 receives the first Bayer image and determines that the image signal processor 80 is in the second mode, the second processing module 70 will be selected or triggered. The second processing module 70 receives the first Bayer image transmitted by the switching module 50 and performs pixel binning processing on the first Bayer image to obtain a third Bayer image (shown in FIG. 10). Then, the second processing module 70 performs Demosaic processing on the third Bayer image to obtain the second image.

Referring to FIG. 10, after pixel binning, a number of pixels in the third Bayer image is the same as the number of pixel units 12, and an area of each pixel in the third Bayer image is equal to an area of the pixel unit 12.

Because the first image is obtained from the first Bayer image through the Remosaic and Demosaic processing, no pixel binning is performed during generation of the first image, so that the number of pixels in the first image is consistent with the number of pixels in the first Bayer image, and the area of each pixel in the first image is equal to the area of each pixel in the first Bayer image. The second image is obtained by combining four pixels of the first Bayer image, and the number of pixels in the second image is the same as the number of pixel units 12 in the first Bayer image. The area of one pixel is consistent with the area of each pixel unit 12 of the first Bayer image. In this way, the number of pixels in the first image is four times the number of pixels in the second image, but the second image and the first image have the same size. Generally, for images with the same image size, the more pixels there are, the higher the image resolution and the clearer the image. Similarly, for an image of the same size, the larger the area of each pixel, the more light signal will be absorbed. Therefore, an image resolution of the first image is higher than an image resolution of the second image, but a brightness of the second image is higher than a brightness of the first image.

In one embodiment, the first mode is a Remosaic mode, and the second mode is a Binning mode. The Remosaic mode performs processing based on each pixel of the first Bayer image, and the first image has a higher resolution. The first Bayer image is filtered by the filter unit 61 to improve a stray light margin and reduce color crosstalk between pixels.

The Binning mode combines several pixels of each pixel unit 12 corresponding to each filter unit into one pixel for processing, thereby increasing the area of each pixel, improving sensitivity, increasing the stray light margin, and reducing color crosstalk between pixels.

In summary, the image processing device 100 is configured with each filter unit corresponding to one pixel unit 12. Each filter unit allows only one type of colored light to pass through, and each micro lens 31 corresponds to one filter unit and one pixel unit 12. In the Remosaic mode of the image signal processor 80, the arrangement of the pixel array 10 is restored to the Bayer array arrangement, and the stray light margin is improved through filtering processing, so that the color crosstalk between pixels is reduced, and the images have a high resolution. In the Binning mode of the image signal processor 80, light is incident on a pixel with a larger area, so that the stray light margin and sensitivity are improved, so that a larger aperture lens can be used. That is, the image processing device 100 can adapt to various focal lengths and scenes and overcome the problems of low image resolution, low brightness, scattered light between pixels, and color crosstalk between pixels of the existing periscope lens due to the small aperture and large pixel area, thereby effectively improving the image quality.

Referring to FIG. 3, the lens module 200 may further include a periscope lens 90. The periscope lens 90 is used to accommodate incident light to pass through, thereby optically imaging on the image sensor 40.

The periscope lens 90 may be located at a telephoto end and/or a wide-angle end. It can be understood that when the periscope lens is located at the telephoto end or the wide-angle end, the image processing device 100 can output the first image or the second image.

It can be understood that when the periscope lens 90 is located at the telephoto end, a focusing distance is long, an incident light angle is small, and a light input is small. When the image signal processor 80 is in the first mode, the pixel arrangement of the first image is restored to the general Bayer array, and the resolution of the first image is improved. When the image signal processor 80 is in the second mode, through pixel binning, stray light is reduced and the sensitivity of the second image is improved, and the second image has less color crosstalk.

It can be understood that when the periscope lens 90 is located at the wide-angle end, the focusing distance is short, the incident light angle is large, and the light input is large. When the image signal processor 80 is in the first mode, the pixel arrangement of the first image is restored to the general Bayer array, the resolution of the first image is improved, and the color crosstalk between pixels is reduced through mean filtering, so that the first mode is more suitable for bright scenes. When the image signal processor 80 is in the second mode, through pixel binning, the sensitivity of the second image is improved. In this way, the second mode is more suitable for dark scenes.

The lens module 200 can effectively overcome the problems of low image resolution and low brightness in the existing periscope lens through the configuration of the image processing device 100.

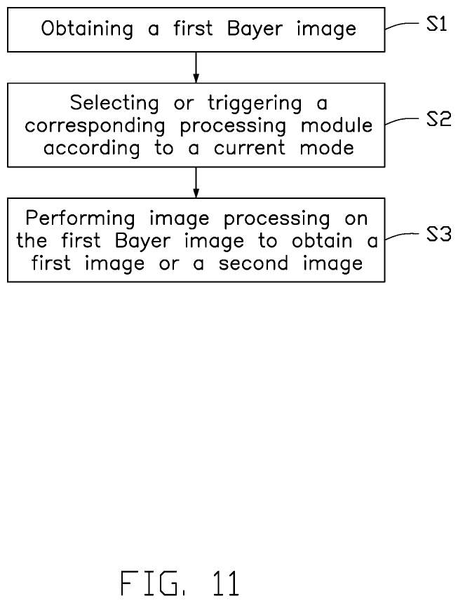

Referring to FIG. 11, an image processing method includes the following blocks. According to different embodiments, the order of blocks may be different, and some blocks may be omitted or combined.

At block S1, a first Bayer image is obtained.

The first Bayer image may be obtained by the image sensor 40 described above. The specific structure and working principle of the image sensor 40 are described above, and will not be repeated here.

At block S2, a corresponding processing module is selected or triggered according to a current mode.

The image signal processor 80 is described above, and will not be repeated here. When the switching module 50 receives the first Bayer image and determines that the image signal processor 80 is in the first mode, the first processing module 60 is selected or triggered. When the switching module 50 receives the first Bayer image and determines that the image signal processor 80 is in the second mode, the second processing module 70 is selected or triggered.

At block S3, image processing is performed on the first Bayer image to obtain a first image or a second image.

When the image signal processor 80 is in the first mode, the first processing module 60 receives the first Bayer image transmitted by the switching module 50 and performs Remosaic processing on the first Bayer image to obtain a second Bayer image. Then, the first processing module 60 performs Demosaic processing on the second Bayer image to obtain the first image.

When the image signal processor 80 is in the second mode, the second processing module 70 receives the first Bayer image transmitted by the switching module 50 and performs pixel binning processing on the first Bayer image to obtain a third Bayer image. Then, the second processing module 70 performs Demosaic processing on the third Bayer image to obtain the second image.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An image processing device comprising:
an image sensor; and
an image signal processor; wherein:
the image sensor comprises a pixel array and a filter array;
the filter array is arranged corresponding to the pixel array;
the filter array comprises a plurality of filter units;
the plurality of filter units divides the pixel array into a plurality of pixel units;
each pixel unit comprises a plurality of pixels;
each filter unit corresponds to one pixel unit and allows only one kind of colored light to be incident on the corresponding pixel unit to generate a first Bayer image; and
the image signal processor is electrically coupled to the image sensor to receive the first Bayer image output by the image sensor and processes the first Bayer image to output a first image or a second image.

2. The image processing device of claim 1, wherein:
the image sensor further comprises a micro lens array;
the micro lens array comprises a plurality of micro lenses; and
each of the plurality of micro lenses is arranged corresponding to one filter unit of the filter array and one pixel unit of the pixel array.

3. The image processing device of claim 2, wherein:
the filter array comprises four filter units arranged in a 2 by 2 array; and
the pixel array is divided into four pixel units by the 2 by 2 array.

4. The image processing device of claim 1, wherein:
the image signal processor comprises a switching module, a first processing module, and a second processing module;
the switching module is used to receive the first Bayer image output by the image sensor and select or trigger one of the first processing module and the second processing module according to a current mode of the image signal processor; and
one of the first processing module and the second processing module processes the first Bayer image to output the first image or the second image.

5. The image processing device of claim 4, wherein:
when the image signal processor is in a first mode, the first processing module receives the first Bayer image transmitted by the switching module and performs Remosaic processing on the pixels of the first Bayer image to obtain a second Bayer image, and then the first processing module performs Demosaic processing on the second Bayer image to obtain the first image.

6. The image processing device of claim 5, wherein:
the image signal processor further comprises a filter unit; and
before the second Bayer image is generated, the filter unit performs mean filtering on each pixel unit of the first Bayer image.

7. The image processing device of claim 4, wherein:
when the image signal processor is in a second mode, the second processing module receives the first Bayer image transmitted by the switching module and performs pixel binning processing on the first Bayer image to obtain a third Bayer image, and then the second processing module performs Demosaic processing on the third Bayer image to obtain the second image.

8. A lens module comprising an image processing device comprising:
an image sensor; and
an image signal processor; wherein:
the image sensor comprises a pixel array and a filter array;
the filter array is arranged corresponding to the pixel array;
the filter array comprises a plurality of filter units;
the plurality of filter units divides the pixel array into a plurality of pixel units;
each pixel unit comprises a plurality of pixels;
each filter unit corresponds to one pixel unit and allows only one kind of colored light to be incident on the corresponding pixel unit to generate a first Bayer image; and
the image signal processor is electrically coupled to the image sensor to receive the first Bayer image output by the image sensor and processes the first Bayer image to output a first image or a second image.

9. The lens module of claim 8, wherein:
the image sensor further comprises a micro lens array;
the micro lens array comprises a plurality of micro lenses; and
each of the plurality of micro lenses is arranged corresponding to one filter unit of the filter array and one pixel unit of the pixel array.

10. The lens module of claim 9, wherein:
the filter array comprises four filter units arranged in a 2 by 2 array; and
the pixel array is divided into four pixel units by the 2 by 2 array.

11. The lens module of claim 10, wherein:
the image signal processor comprises a switching module, a first processing module, and a second processing module;
the switching module is used to receive the first Bayer image output by the image sensor and select or trigger one of the first processing module and the second processing module according to a current mode of the image signal processor; and
one of the first processing module and the second processing module processes the first Bayer image to output the first image or the second image.

12. The lens module of claim 11, wherein:
when the image signal processor is in a first mode, the first processing module receives the first Bayer image transmitted by the switching module and performs Remosaic processing on the pixels of the first Bayer image to obtain a second Bayer image, and then the first processing module performs Demosaic processing on the second Bayer image to obtain the first image.

13. The lens module of claim 12, wherein:
the image signal processor further comprises a filter unit; and
before the second Bayer image is generated, the filter unit performs mean filtering on each pixel unit of the first Bayer image.

14. The lens module of claim 13, wherein:
when the image signal processor is in a second mode, the second processing module receives the first Bayer image transmitted by the switching module and performs pixel binning processing on the first Bayer image to obtain a third Bayer image, and then the second processing module performs Demosaic processing on the third Bayer image to obtain the second image.

15. An image processing method comprising:
obtaining a first Bayer image;
according to a current mode, selecting or triggering a corresponding processing module; and
performing image processing on the first Bayer image to obtain a first image or a second image.

16. The image processing method of claim 15, wherein:
in a first mode, the first Bayer image is processed by Remosaic processing to obtain a second Bayer image, and then the second Bayer image is processed by Demosaic processing to obtain the first image.

17. The image processing method of claim 16, wherein:
in a second mode, the first Bayer image is processed by pixel binning processing to obtain a third Bayer image, and then the third Bayer image is processed by Demosaic processing to obtain the second image.
